(19) United States
(12) Patent Application Publication
(10) Pub. No.: US 2025/0245528 A1
(43) Pub. Date: Jul. 31, 2025

(54) SYSTEMS AND METHODS FOR AUTOMATED CONTENT CREATION ASSISTED BY ARTIFICIAL INTELLIGENCE (AI)

(71) Applicant: FactFirst, Inc., Chicago, IL (US)

(72) Inventors: Karen WEBSTER, Boston, MA (US); David EVANS, Boston, MA (US); Shaunt SARKISSIAN, Boston, MA (US); Dave CAMPBELL, Boston, MA (US)

(21) Appl. No.: 19/041,641

(22) Filed: Jan. 30, 2025

Related U.S. Application Data
(60) Provisional application No. 63/626,653, filed on Jan. 30, 2024.

(51) Int. Cl. G06N 5/022

(52) U.S. Cl. CPC G06N 5/022

(57) ABSTRACT

A systems and methods provided for generating a news article assisted by Artificial intelligence (AI), and a storage medium. The method comprises selecting input source material, obtaining the words and structured data of the information conveyed by each input source material selected, generating a writing model based on the information obtained, wherein AI assists the writing model to automatically create a news article. The writing model assisted by AI generates creative and accurate content by addressing the drawbacks related to (1) hallucinations, (2) extraneous data, (3) input structure constraints, (4) rewritten quotes, and (5) errant time references.

### CROSS-REFERENCE TO RELATED APPLICATIONS

This application claims the benefit of U.S. Provisional Patent Application 63/626,653 filed Jan. 30, 2024, incorporated by reference it its entirety.

### FIELD OF THE INVENTION

The invention is generally related to Internet technologies and improving output performance of systems and methods assisted by artificial intelligence (AI). More particularly, the invention is related to automatically creating content from one or more sources and assisted by AI so that the generated content is both creative and accurate.

### BACKGROUND OF THE INVENTION

Artificial intelligence (AI) generally refers to the intelligence of machines or software. AI is an emerging technology to research and develop methods and systems for expanding and simulating human intelligence. AI is a branch of computer sciences that produces machine capable responses based on and comparable to human intelligence. AI studies have been directed to a wide array of applications including robots, language recognition, image recognition, natural language processing, expert systems and the like.

Specifically, AI is used to develop models that changes the approach to addressing complex problems. AI models have been shown to increase efficiency and revenue by accomplishing more in less time, predicting outcomes, and performing complicated tasks.

Generative AI is a particular type of AI that uses generative models to produce forms of data such as text, images, videos. Generative AI models learn characteristics (like patterns and structures) of their training data and use them to produce new data based on the input.

There is a large need for AI generated content that is simultaneously creative and accurate, particularly in the communications industry. Media includes mass communication (broadcasting, publishing, and the Internet) of information such as news and involves writers including news reporters, journalists, and publicists. Every vertical news publisher, digital magazine, newsletter publisher, content creator and blogger is trying to figure out how to use AI to do more with fewer resources. Some are already using Generative AI to help write articles-without citing sources, making their content generic and untrustworthy. And it has been shown that the more creative the AI model is, the less accurate it tends to become. And vice versa. This is largely due to one or more known drawbacks of AI assisted content generation including: (1) hallucinations, (2) extraneous or erroneous data, (3) input structure constraints, (4) rewritten quotes, and (5) errant time references.

Hallucinations occur when an AI model completely fabricates information. This issue not only plagues those ordinarily skilled in the art, but even plagues those with significant expertise. It is known that chatbots sometimes make things up. As an example, one lawyer infamously used OpenAI's ChatGPT to search for legal citations. However, ChatGPT made up cases that did not even exist. (ChatGPT: US lawyer admits using AI for case research-BBC News, May 27, 2023, https://www.bbc.com/news/world-us-canada-65735769). The lawyer even asked ChatGPT if these were real cases, with ChatGPT explicitly stating “yes”. Moreover, ChatGPT claimed the cases came from the foremost databases of case law even though the non-existent cases are not found in these databases.

Another example of the challenge of accuracy versus creativity is exemplified in CNET's attempt to use AI for news stories. (A news site used AI to write articles. It was a journalistic disaster, Aug. 9, 2023, https://www.washingtonpost.com/media/2023/01/17/cnet-ai-articles-journalism-corrections/).

Extraneous data is another issue that needs to be resolved and refers to the fact that many documents and websites contain information unrelated to the central subject matter. For example, a PDF document regarding the cause of rampant inflation may also contain a large amount of legal disclaimer language. Merely asking the AI to use the document to create a blog post may result in the AI writing about legal disclaimers. Another example is a website including a news page that usually contains meta information, navigation information, information in the side bar, advertising information, and more. Should this webpage be used as an input source, such extraneous information should not be considered.

Input Structure Constraints are an issue affecting unbounded creativity. Large Language Models translate the input—i.e., prompts-into numerical tokens. Then the output is generated from the tokens. When the input is structured, it inherently constrains the output. For example, if a Large Language Model such as ChatGPT attempts to write a news story based on a transcript, the structure of the transcript constrains the final result. Rather than merely write the information in a news format, it will often return to “So and so asked . . . ” and “So and so replied.” Or even, “the host of the show said . . . ”

Another example is a content creator interviewing a client regarding the client's products. The content creator may want to provide the transcript to the AI and have the AI generate product descriptions for the client's catalogue and generate the content for the client's landing page. The AI will often include references to the interview itself producing plagiarized, unusable content. Even when one explicitly prompts the AI not to do so, it still does so since the probabilistic model takes precedence.

AI models often inherently rewrite quotes. This too is often something that one cannot tell the AI to do. Asking many Large Language Models to keep quotes verbatim is a fool's errand. The entire mathematical principle of creativity is based on choosing the words in a semi-random manner. But writing quotes with semi-random words makes the quotes inaccurate. It makes the quotes wrong. And there is a recent example of an engineer unsuccessfully begging and pleading with ChatGPT to preserve quotes.

Another extremely large issue is the problem of errant time references. Consider a document that says: “I saw the killer at the bar last night.” If the AI is tasked with writing a news story, it will say that the killer was seen at the bar last night even if the interview was taken a week ago. Even providing the date of the interview is of no avail. Large Language Models do not have awareness of chronology. This results in three issues: 1) past events are described as occurring at a time when they did not; 2) multiple past events can be described as occurring out of order, i.e., in a different sequence than they actually did; and 3) past events can be described as if they are events to occur in the future.

For example, consider a document that says, “John Smith will attend the conference next week.” The document may be many years old. Yet, from the perspective of the Large Language Model, John Smith's attendance is still a future event. This issue of errant time references not only plagues those normally skilled in the art, but even those with great expertise. For example, a Perplexity search for a court case performed on May 9, 2023 returned information stating that the Defendant “is scheduled to make his initial appearance in Manhattan criminal court on Apr. 4, 2023 . . . ” The AI generated response presented a past event as if it were still to occur in the future even though both the current date and prior event date were known.

There is a large need for AI generated content that is creative and accurate, particularly in the news industry. What is needed are systems and methods that automatically create content, such as publications or articles, from one or more source materials and that is generated with creativity and accuracy. The invention satisfies this need.

### SUMMARY OF THE INVENTION

The systems and methods according to the present invention resolves the issues that prevent using AI to creatively generate accurate, ready-to-publish, reliable news articles and provides a major opportunity to increase productivity, address consistent quality challenges, and engage audiences with real, quality tangible content.

More specifically, the invention is directed to improve AI performance by leveraging large language models and Generative AI. A computer-implemented method for improving performance of AI models uses one or more source materials to produce generated output content that is simultaneously creative and accurate, and references and cites sources, and make suggestions to the final edited version of the article where changes and/or additions should be considered before publishing.

Some examples in which the present invention may be utilized include a journalist writing a story that includes interviews and a blog writer wanting to write about a topic with up-to-the-second information available from multiple sources, e.g., the most purchased electric toothbrush.

According to one embodiment of the invention, a computer-implemented method for generating a news article assisted by AI comprises the steps of: entering a length of output; selecting two more source materials and determining a length of each of the selected source materials; obtaining word information and structured data information of each of the two or more selected source materials; generating a writing model according to the obtained word information and structured data information, comprising the steps of: normalizing time of the source materials; extracting content from the source materials; choosing quotes from the extracted content; then, output content is generated, wherein the output content matches the entered length; errant quotes in the output are corrected; the accuracy of the output verified before displaying the output content wherein the length of the output is less than or equal to the length of the input source materials.

The output selected may be a news article, a blog post, an interactive outline, or a custom output. And the length of the output may be selected from a concise from, a short form, a long form, or an exhaustive form. Again, the length of the output is less than or equal to the length of the input source materials. The source materials may be anything the comprises content, for example, an Internet search, a link, a file, a text.

As known in the art, a Large Language Model (LLM) is a deep learning algorithm that can perform a variety of Natural Language Processing (NLP) tasks. LLMs typically cannot process ambiguous, open-ended instructions (such as ‘less than or equal to’), but can follow explicitly defined lengths (such as number of paragraphs or number of words). Accordingly, the invention uses defined lengths to generate output content.

An advantage of the invention is to provide an output defined with a length that is less than or equal to a length of an input source material. To exemplify, when an AI model is asked to write a 1,200 word news article on a specified topic, the AI model produced a 1,200 word essay on something entirely different, i.e., a topic completely unrelated to the requested topic. Upon investigation, it was found that none of the source material was sent to the AI even though the AI had an explicit topic to write about. The fact that it had zero source materials caused it to enter a mode where it simply wrote whatever it wanted, about whatever it wanted.

In this instance, the input length was significantly less than the requested output length (given it was zero). Thus, it is clear that there is a relationship between lengths of input material and generated output content.

Considering an example where the input is 300 words yet the AI model is asked to write 600 words. The request itself can only be fulfilled in two ways: (1) the AI model can duplicate the content contained in the 300 words (which it occasionally will do) or (2) the AI model can write whatever it wants to fill the desired length (which if often does). Now, considering the reverse situation, where the input is 600 words and the desired output is 300 words, and the 600 words are relevant to the desired topic, the AI model can easily write the 300 words without leaving the confines of the 600 words of input. Therefore, the 300 words are both accurate and creative. Plagiarism is entirely avoided.

Merely having a 600 word input and requesting a 300 word output does not inherently overcome the hallucination problem. For example, consider the example where the input is 600 words regarding horses and the requested output is 300 words regarding dogs. Such a situation is ripe for hallucination-laden output. However, the invention extracts relevant information which forms the input for the creative AI process. It is this combination of steps in the appropriate sequence that reliably abates the issue of hallucinations.

The process of combining one or more source materials into a different form means that the universe of possible correct quotes is fully available-found within the source materials themselves.

Yet, even with all the preprocessing, the creative AI model in producing generated content will often rewrite quotes, even when explicitly instructed not to. That is because the mathematical, probabilistic method that produces creativity takes precedence over that command.

According to the invention, great latitude is given to generating output content. AI language models often include settings that dictate the latitude which the model can use in fulfilling an instruction. For example, a latitude of 100 means that only the highest probable word is chosen at each instance. In this case, the AI model would likely be accurate, but completely devoid of creativity. With a latitude of 80 the AI model chooses the highest probable word 80% of the time, and 20% of the time it start to choose some of the next high probability words. In this case, it is creative. As yet another example, consider a setting of 60% so that the highest probable word will be chosen 60% of the time. In this case, while the quotes will be rewritten, they will still be similar to the original. That is because the other words used 40% of the time will be similar to the original word, even if not an exact match. The lower the latitude number, the greater the next high probability words are chosen and therefore the greater the creativity. Thus, to preserve quotes verbatim a zero latitude is desired, i.e., the most probable word is the verbatim word and will therefore always be chosen. The latitude value effects the way in which the command itself is followed.

It is such tension between creativity and accuracy that's plagued AI models. According to the invention, the AI model is given great latitude to achieve unbounded creativity. This will, in turn, often result in rewritten quotes. The key constraint is to open the latitude wide enough so that the AI model can have maximal creativity while staying on topic. Such latitude ranges are known relative to the LLM being used. For example, there are many discussions on how to set ChatGPT to be maximally creative while remaining on topic. In other words, if the latitude is set such that the highest probable word has close to 0% of being chosen, then the line has been crossed where the output will not only be creative, but may also be off topic.

Ideally, the constraint should remain within the known creative bounds for the chosen LLM, with a deference to using the most creative settings that preserve the topic. This latter condition is necessary for correcting the quotes.

The present invention relies on a latitude setting that preserves sufficient similarity between the rewritten quote and the original quote verbatim. However, even the most creative settings that are within the bounds of the recommended settings preserve sufficient similarity for errant quotes. However, if an embodiment is chosen wherein the quotes are not being corrected with 100% accuracy, then the latitude value must be changed to reduce the latitude. The ideal embodiment for any given LLM is to widen the latitude settings as much as possible until there is no longer a 100% restoration of quotes. Then the latitude settings should be lowered from that threshold to ensure the best combination of unbounded creativity with a fully accurate final result.

Another embodiment of the invention is directed to a system and methods for generating content that utilizes a user interface comprising a first portal to receive a selection of content for consideration by a processor and a second portal to process the selected content.

Another embodiment of the invention is directed to a fact screening system and method permitting content to be searchable and verifiable, which may be communicated by an accuracy score that is calculated using comparison values.

The present invention and its attributes and advantages will be further understood and appreciated with reference to the attached figures of presently contemplated embodiments. Further modifications and alternative embodiments of various aspects of the invention will be apparent to those skilled in the art. Accordingly, this description is to be construed as illustrative only and is for the purpose of teaching those skilled in the art the general manner of carrying out the invention.

### BRIEF DESCRIPTION OF DRAWINGS

The preferred embodiments of the invention will be described in conjunction with the appended drawings provided to illustrate and not to limit the invention.

FIG. 1 is a flowchart of an embodiment of a method of generating content by creating news articles according to the present invention.

FIG. 2 is a flowchart of an embodiment of a method of generating a writing model according to the present invention.

FIG. 3 is a flowchart of an embodiment of a method of generating the writing model on time references according to the present invention.

FIG. 4 is a flowchart of an embodiment of a method of generating the writing model on accurate quotes according to the present invention.

FIG. 5 is a schematic diagram of a translated sequence framework for generating content by creating a news article according to the present invention.

FIG. 6 is a block diagram of an apparatus of generating content by creating a news article according to the present invention.

FIGS. 7A-7P are schematic diagrams of an automated content generation interface according to the present invention.

FIG. 8 illustrates a block diagram of an example computer system/server adapted to implement the present invention.

FIG. 9 illustrates an exemplary cloud computing system for use with the present invention.

### DETAILED DESCRIPTION OF THE INVENTION

The present invention improves performance of AI models. Specifically, the AI generated content uses one or more source materials to produce generated output content that is simultaneously creative and accurate. The present invention provides a platform and services that can be offered over the Internet, which enable publishers to write unique articles that reference and cite sources (specific articles), leverage large language models and Generative AI, and make suggestions to the final editor where changes and/or additions should be considered before publishing. Content is generated through a user interface comprising portals to receive and process a selection of content. The content may be searchable and verifiable, and assigned an accuracy score.

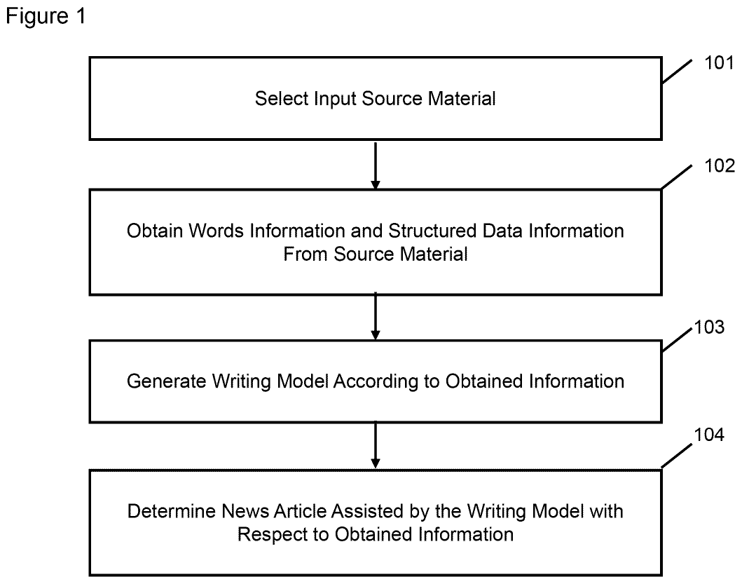

FIG. 1 is a flowchart of an embodiment of a method of generating content by creating news articles according to the present invention. While the invention is discussed and described in reference to a news article in written form, any output (book, magazine column, interview, review, editorial) in any form (spoken audio, TXT, PDF, DOC) is contemplated by the present invention. It is the steps performed, and assistance of AI, which provides a unique and novel solution to automatically create content from two or more source materials to generate output content that is simultaneously creative and accurate.

Input source material is selected shown by step 101. Input source material may be anything that conveys information such as news and in any form, including for example, text file, audio file, video file, picture file, markup language file, Internet/web address file, etc. Specific types of files include, e.g., PDF, JPEG, PNG, GIF, DOC, DOCX, TIFF, SGML, RTF, ZIP, BMP, EPS, MP4, CSV, AVI, MOV, WAV, HTML, XLS, XML, PPT, STL, PST, URL, TXT, etc.

The words and structured data of the information conveyed by each input source material is obtained at step 102. Based on the information obtained, a writing model is generated shown by step 103. AI assists the writing model to determine a news article with respect to the information obtained from the selected input source material shown by step 104.

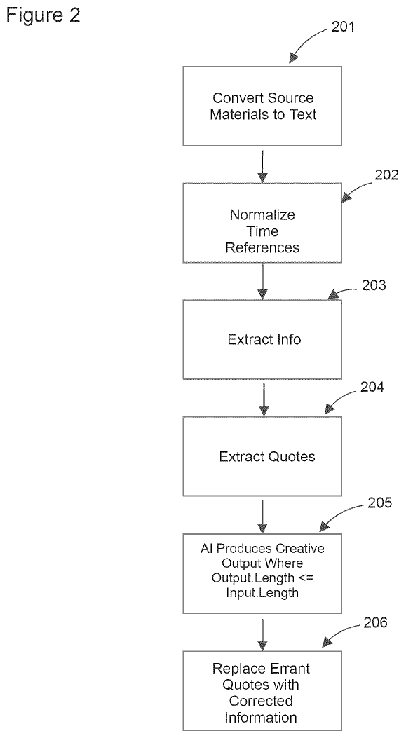

FIG. 2 is a flowchart of an embodiment of a method of generating a writing model according to the present invention. At step 201, it is determined if the input source material is in text format. For example, by looking at the file extension of the input material. If the input source material is not in text format, then at step 120 the materials are converted to a text file—e.g., TXT—by any known method in the art, e.g., online tools that transcribe content from a MOV file or a MP4 file into a TXT file.

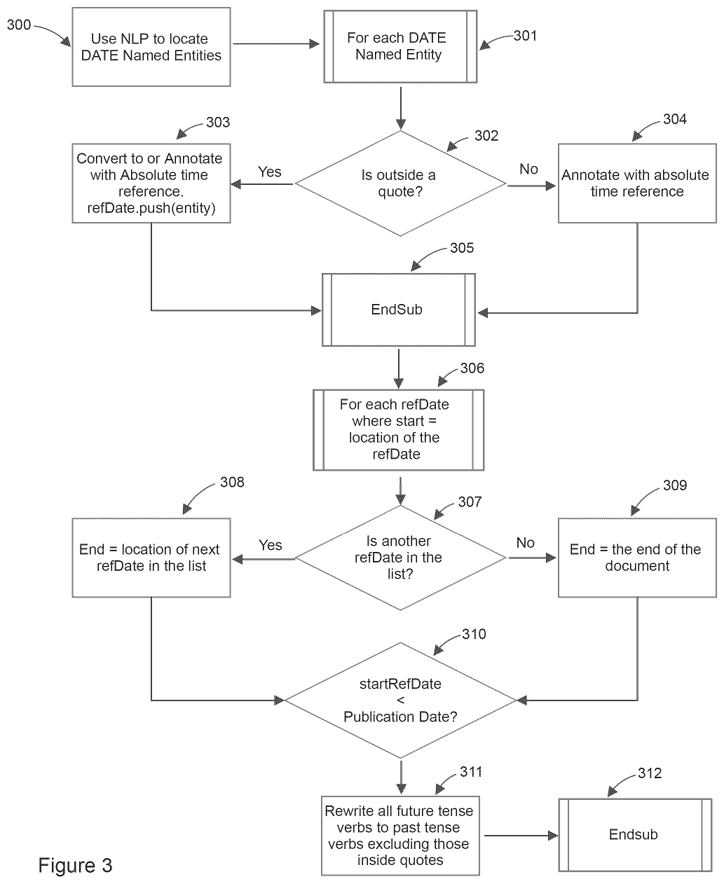

At step 202, the time references are normalized using the text of the input source material. One embodiment for normalizing time between the materials is shown and described in FIG. 3.

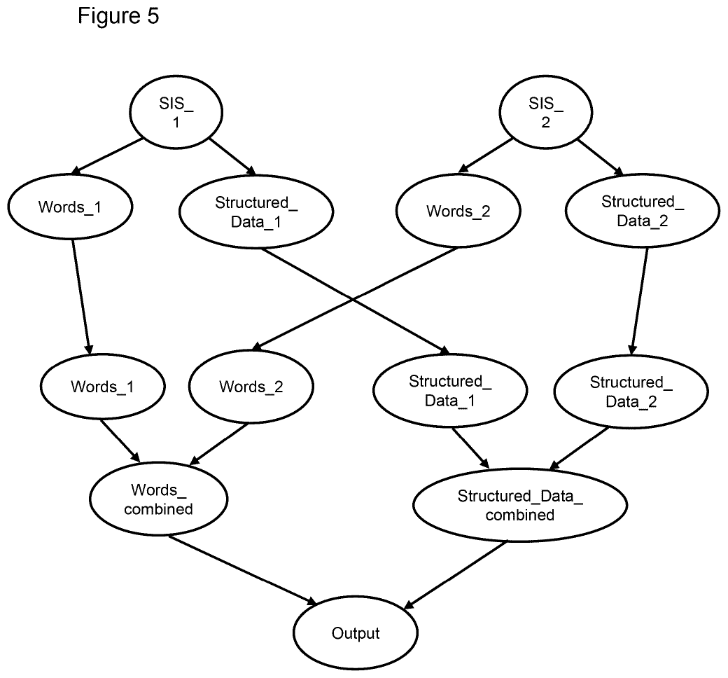

At step 203, content is extracted from input source material. When there are two or more input source materials, they may be combined prior to content being extracted or content may be extracted from each source material and then each of this content is combined. See FIG. 5.

Content is extracted based on an entered input, e.g., an entered input for a particular subject: “dogs”, “pears”, etc. Specifically, content of the input source material that relates to the entered input—e.g., one or more words—is extracted. Relation may be determined by any method. As an example, the input source materials are searched for words that exactly match the entered input letter-for-letter, or for words that have the same or similar meaning to the entered input.

At step 204 quotes are selected from the extracted content. It is contemplated that the quotes may be extracted from combined content from two or more input source materials, or from each source material individually before being combined. A quote is the text found between quotation marks. It is contemplated that the invention may use only an open quotation mark, only an end quotation mark, or both an open and end quotation mark. For purposes of this application, a quotation mark may be a single quotation mark (′) and/or a double quotation mark (”). There are multiple methods well-known in the art for extracting verbatim quotes from text.

It should be noted that while the extraction of quotes can be done at a different stage, there are certain sequential steps that must be performed to consistently produce a desired result. Normalizing time references must precede information extraction. When the sequence is reversed, the time references can be confused by the system during information extraction, thereby complicating, if not thwarting, the ability to normalize the time references thereafter, i.e., the computer will normalize errant references to time.

Output content is created and generated as a news article for publication. One method for generating output content includes step calculating a length of the input, referred to as “input length” and defining an “output length”, or a length of the output content, wherein the output length meets a certain criteria. According to one embodiment of the invention, this criteria is set at a value of less than or equal to the input length as shown by step 205.

The term “length” may refer to a number of letters, a number of words, a number of paragraphs, a number of pages, etc. For example, if the input length is 5 paragraphs, then the defined output length of 4 paragraphs satisfies the set criteria. It is also contemplated that the defined output length may be specified as a range or portion of the input length. According to one embodiment, a defined out length of 75-85% of the input length generates an output content with an ideal balance of creativity and accuracy.

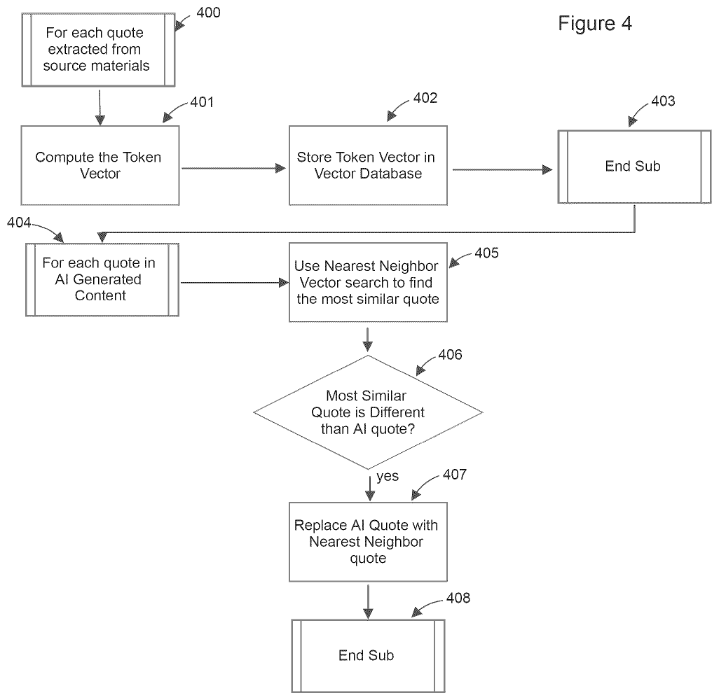

At step 206, it is determined if there are quotes with errors. For example, if a word is missing or misspelled. If so, the quotes are corrected at step as further described in reference to FIG. 4.

FIG. 3 is a flowchart of an embodiment of a method of generating the writing model on time references according to the present invention. Time must be normalized between the source materials.

According to Natural Language Process (NLP), Named Entity Recognition (NER) may be performed to locate all time references in the text of the input source material shown at 300.

It is contemplated that NER may be performed to detect and categorize important information in text referred to as “named entities”. Named entities text refers to the key subjects of a text, such as subjects, themes, topics, names, locations, companies, events, services, products, as well as dates, monetary values, and percentages, to name a few. Here, NER is used to identify a primary time reference at step 300, or absolute time reference, such as a date of publication, date of acceptance, or a date or authorship or any secondary time reference dates, or simply secondary dates. It is contemplated dates are expressed as month, day, year, but any convention is contemplated. Secondary time reference dates are those that do not equal the primary date as well as dates expressed as an adverb in time, e.g., yesterday, tomorrow, a week ago, last month, day of the week, last Monday, etc.

First, the location of all time references is accomplished using NER as is well-known in the art of NLP. Then the following subroutine is run for each identified date shown by steps 301-305. If the time reference is inside a quote (step 302) then the time reference is annotated with the absolute reference (step 304). For example, if a witness said, “I saw the killer in the bar yesterday” the quote can be annotated “I saw the kill in the bar yesterday [Jan. 3, 2022].”

However, the following step is essential when writing news stories and blog posts that include relative time references that are outside of quotes. At step 303, the relative time reference is either converted to an absolute time reference or at least annotated. The former is preferred since it eliminates error. For example, consider an article published on Jul. 10, 2021: “The conference convened yesterday.” The converted sentence could be: “The conference convened Jul. 9, 2021.” Any absolute reference could be used or the time reference could alternatively be annotated. The time reference could alternatively include both an absolute reference and an annotation.

FIG. 3 also includes the step of add time references outside of quotes into a list (refDate). Hence, at step 306 there exists a list of time references excluding those that are found in quotes. Also, the text has already been modified for any relative time references within that list. The altered text and the list are processed in a subroutine shown at steps 306-312.

For each refDate (step 306) the starting point is the location of that refDate. This location is defined as a first refDate and a starting point in the text. Then, for each refDate in which there is another refDate afterwards, the ending point is the next refDate (steps 307-308). However, for the final refDate, the endpoint is the end of the text itself (steps 307-309).

The starting and ending points are subsection of the text (or the entirety of the text itself where there is only one refDate and such refDate is the first word of the document). If the starting point's refDate is less than the date of the article's intended publication date (step 310), then the portion of text between the starting and ending point is rewritten so that all future tense verses are stated as past tense verbs (step 311). It is optional to change the verb tenses within quotes at this point. If an embodiment uses the quote correction process then the verb tenses are restored at that time. It should be noted that the tokenization of a quote in which the verb tenses are changed should result in a match with the original quote as the vector token of the original quote will still be its nearest neighbor.

At the exit of the subroutine (Step 312) the portions of the text that once referred to future events that have already passed are correctly rewritten as having occurred in the past. Meanwhile, all references to events that are still to occur will maintain their future tense verbs.

FIG. 4 is a flowchart of an embodiment of a method of generating the writing model on accurate quotes according to the present invention. FIG. 4 is directed to nearest-neighbor token vectorization storage and retrieval to correct errant quotes. Selected quotes are identified in the source materials and extracted. These selected quotes are the original quotes from the input source materials. For each original quote extracted from source materials (step 400), a token vector is computed (step 401) and stored in a database. Nearest-neighbor token vectorization is used to store the token vectors of the original quotes (step 402). Then, a token vector is created for each quote in the AI-assisted generated output (step 404) and a nearest neighbor search is performed (step 405) to find the closest quote in the original source materials. If the most similar quote is different than the AI-assisted generated quote (step 406), then the AI-assisted generated quote is replaced with the original quote (step 407). Alternatively, the AI-assisted generated quote may be replaced with the NNS quote. the quotation marks in the AI-assisted generated content can be removed in lieu of replacing the quote. Optionally, the quotation marks can be removed. It should be noted that the tokenization of a quote in which the verb tenses are changed should result in a match with the original quote as the vector token of the original quote will still be its nearest neighbor.

The writing model employs a translated sequence framework. FIG. 5 is a schematic diagram of a translated sequence framework according to the present invention. If an input source material is not input as text, (e.g., a video file), it is serialized into text. As shown in FIG. 5, the word information and structured data information from the selected input source material is serialized into text so that it can be combined, in parallel, based on similarity of the serialized information. A Large Language Model (LLM) is used to enable parallel processing of text sequences, which significantly speeds up computation. Then, the combined information is translated into an output text sequence.

A LLM is primarily focused on NLP of human language. It is a powerful tool for automating and enhancing interactions between text. According to the present invention, the writing model uses LLMs that use deep learning algorithms, particularly a transformer architecture, to analyze vast amounts of text data, allowing them to understand the relationships between words and generate human-like text by analyzing and combining two or more reference sources, and mimicking how humans communicate in natural language achieved through the writing model that weighs the importance of different parts of the input text to generate contextually relevant output.

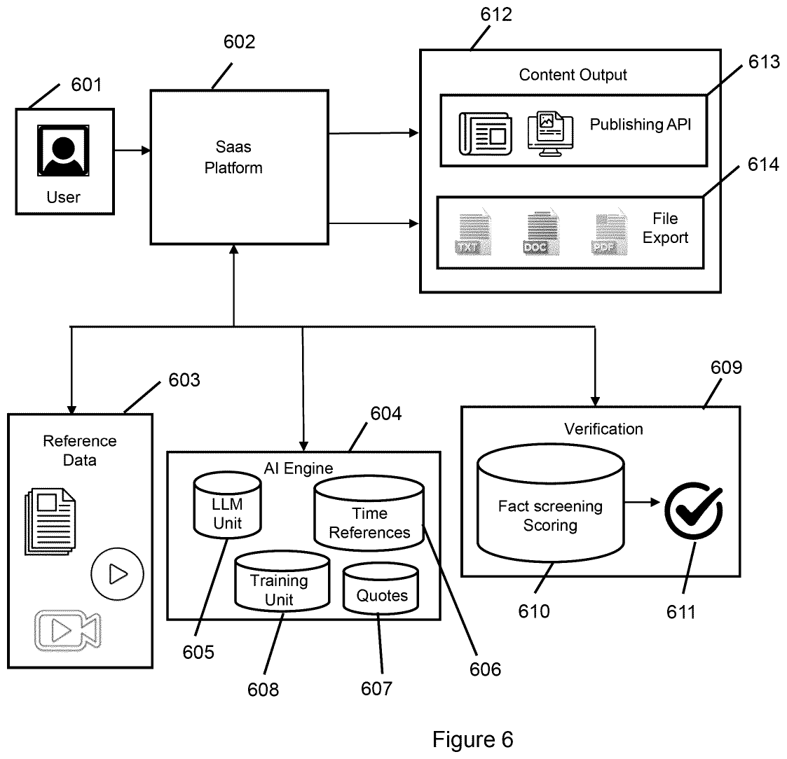

FIG. 6 is a block diagram of an apparatus of generating content by creating a news article according to the present invention. A user 601 accesses the platform 602 that includes an AI-assisted writing model to create content from one or more sources that is both creative and accurate. The selected input source material 603 may include anything that conveys information such as news and in any form, e.g., text file, audio file, video file.

The words and structured data of the information conveyed by each input source material is obtained to generate a writing model assisted by AI 604. The writing model is assisted by AI to determine a news article with respect to the information obtained from the selected input source material using a LLM unit 605, time references unit 606, quotes unit 607, and a training unit 608. The LLM unit 605 is used to perform a variety of NLP tasks configured to align the word information and structured data information to obtain a combination of word and structured data information used to generate a writing model. For example, the LLM unit may perform slot extraction on the word information and structured data information to remove redundant information and to extract features from the information.

The time references unit 606 is detailed and described in FIG. 3 and the quotes unit 607 is detailed and described in FIG. 4, which are both also used to generate the writing model.

The training unit 608 is configured to receive and store the results of the work performed by the LLM unit 605, time reference unit 606, and quotes unit 607 to generate historical information used by the writing model.

The training unit 608 may be used to build templates with slots extracted by the LLM unit. In one embodiment, the training unit 608 is used to create feature vectors according to features extracted by the LLM, with each feature corresponding to one dimension in the feature vector. The feature vectors are used to generate one or more templates with slots that may be populated using the selected reference materials.

The content generated is then verified. The verification architecture 609 includes fact screening and scoring 610 to confirm verification 611. If verification is confirmed, the content is output 612. The output content may be published to an Application Programming Interface (API) including hard copy documents such as newspapers, newsletters, magazines, etc. or to a file exported in any format, e.g., TXT, PDF, DOC.

Verification is performed by fact screening and scoring the output content created. An important part of the content generated by the present invention is to verify and fact-check to protect the content from errors or false information.

The subject matter of the generated content is analyzed by searching for existing materials or other forms of media related to the topic and included in sources other than, or outside, those selected as input reference sources. This may include social media, any internet content, publications, and news repositories. However, it is contemplated that the selected input reference sources may be used to analyze the generated content.

All outside sources are gathered and compared to the content generated. Any discrepancies between the sources and the generated content is assigned a negative value, −1 for one discrepancy, −2 for two discrepancies, and so on. Discrepancies include those related to error or bias, figures, numbers, and rates such as percentages. To ensure the content is accurate and reliable, the content generated is assigned an accuracy score. The content generated with an assigned accuracy score that meets a threshold value is output. With a threshold value of 0, any generated content with a score of 0 is considered the most accurate and reliable. Of course, the threshold value may be −1 so that content with a score of 0 or −1 may be output. Alternatively, the accuracy score may be communicated as a percentage, for example, an accuracy score of 0 equates to 100% accuracy, a −1 accuracy score equates to 90%, a −2 accuracy score equates to 80%, and so on. Many other variable may be introduced into the scoring algorithm, including but not limited to the quality/ranking of the source itself (by internal or externally derived metrics), third party scoring models/data, velocity of source content, propagation of source content, applicable global web searched, and other quantitative and qualitative data metrics.

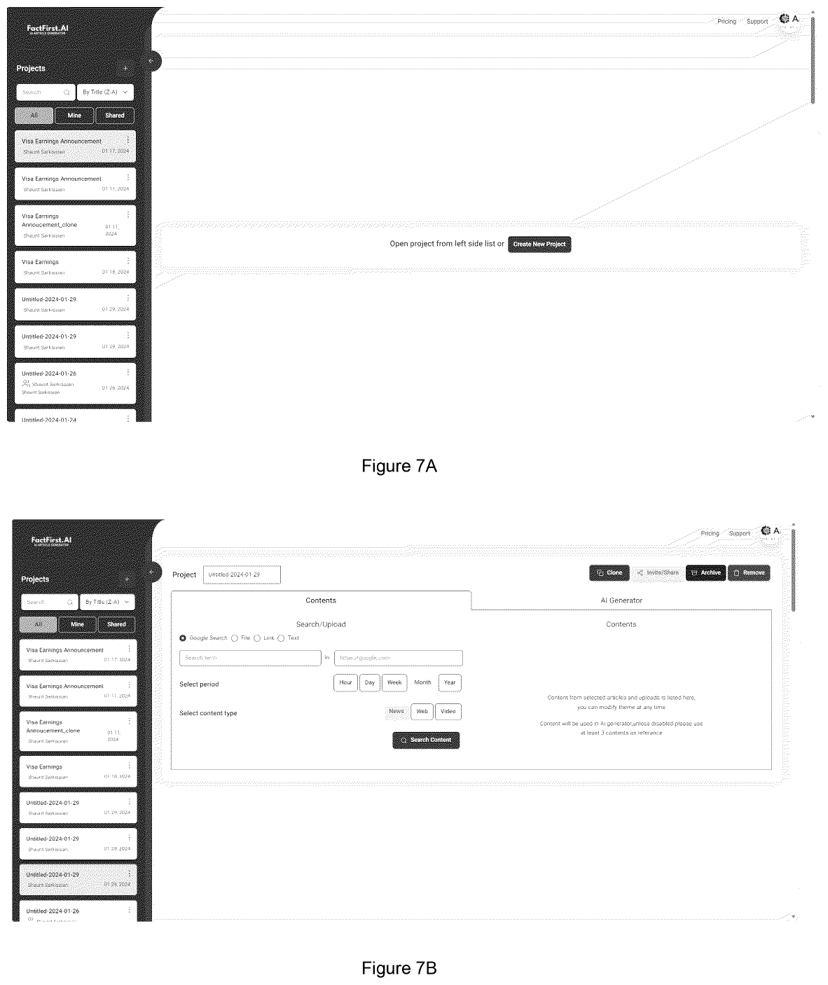

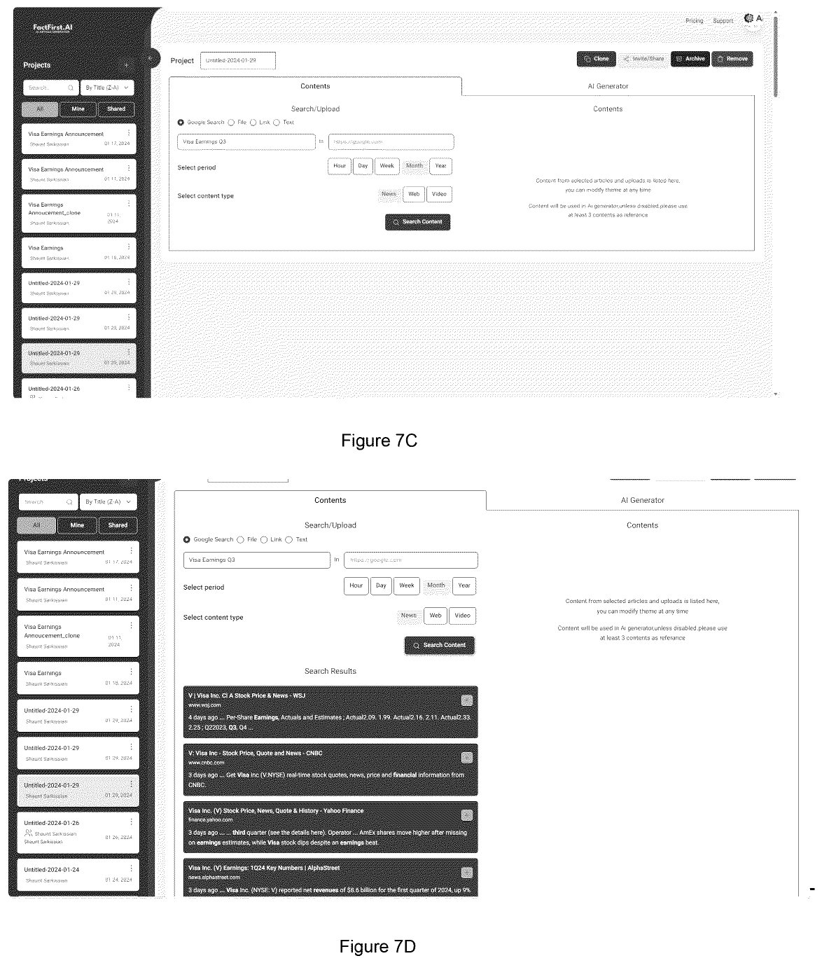

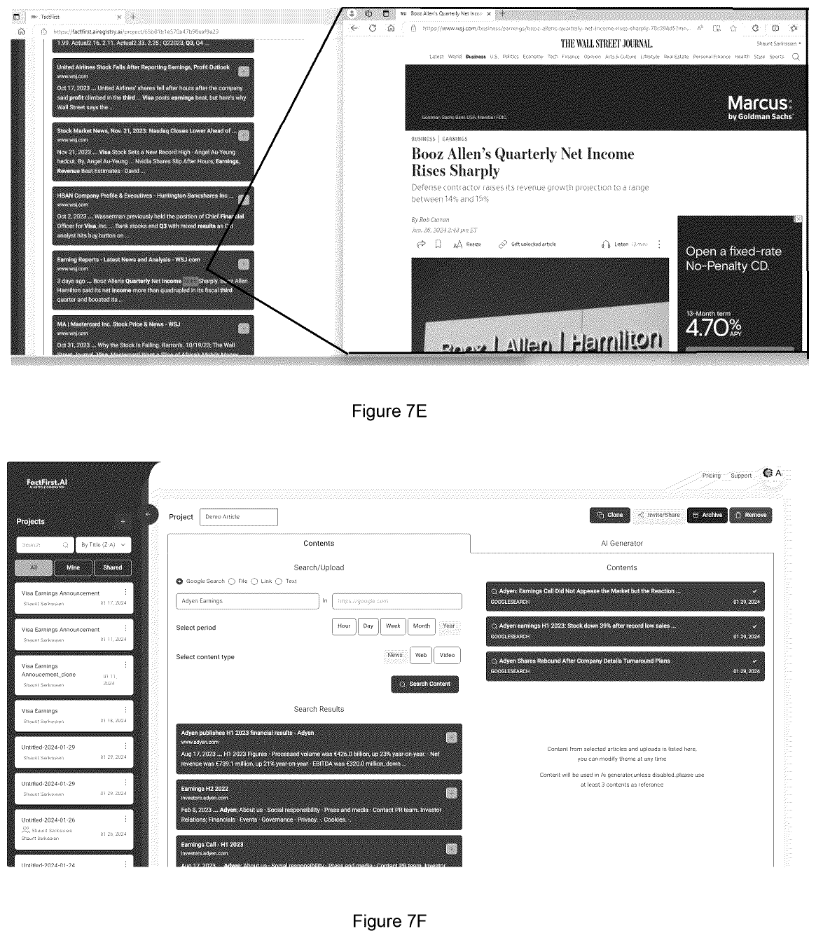

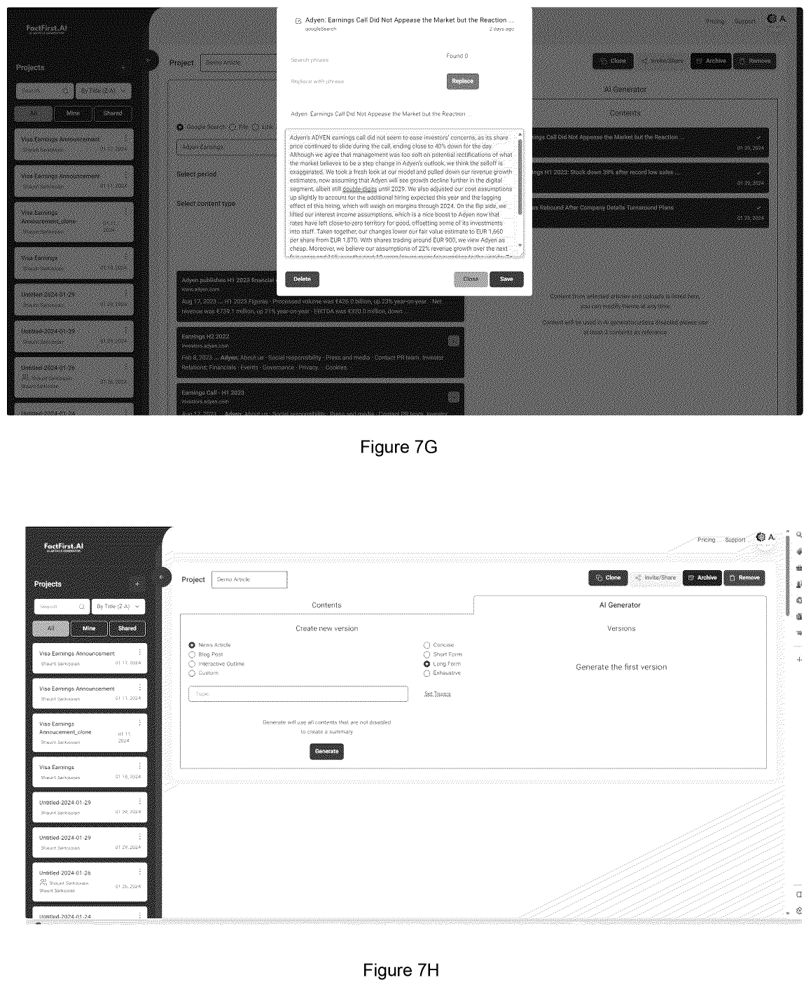

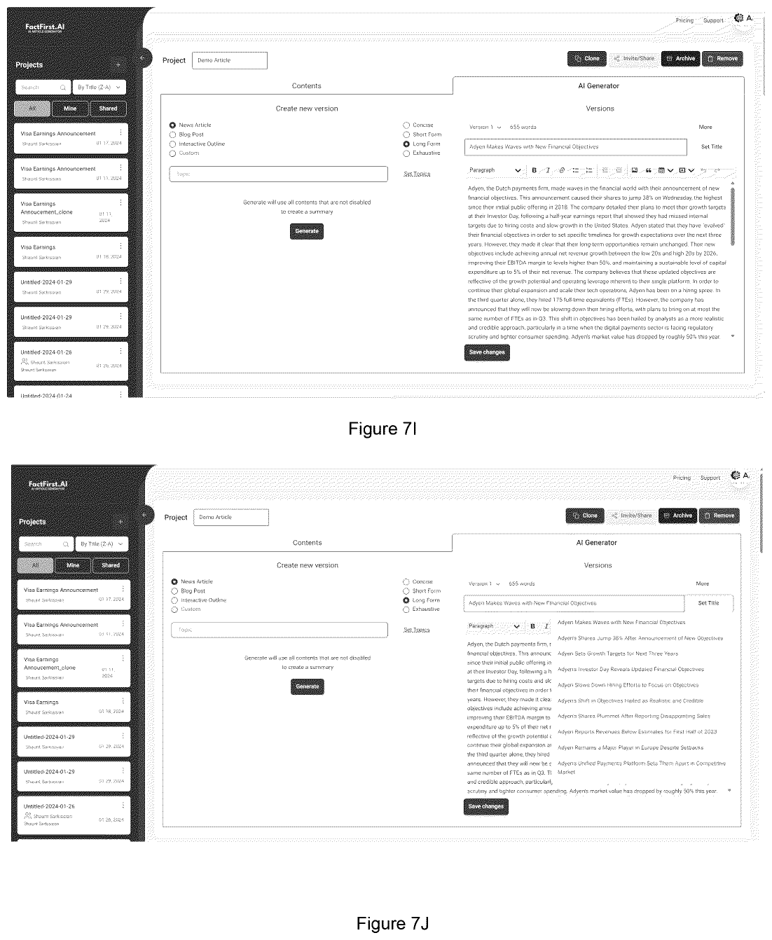

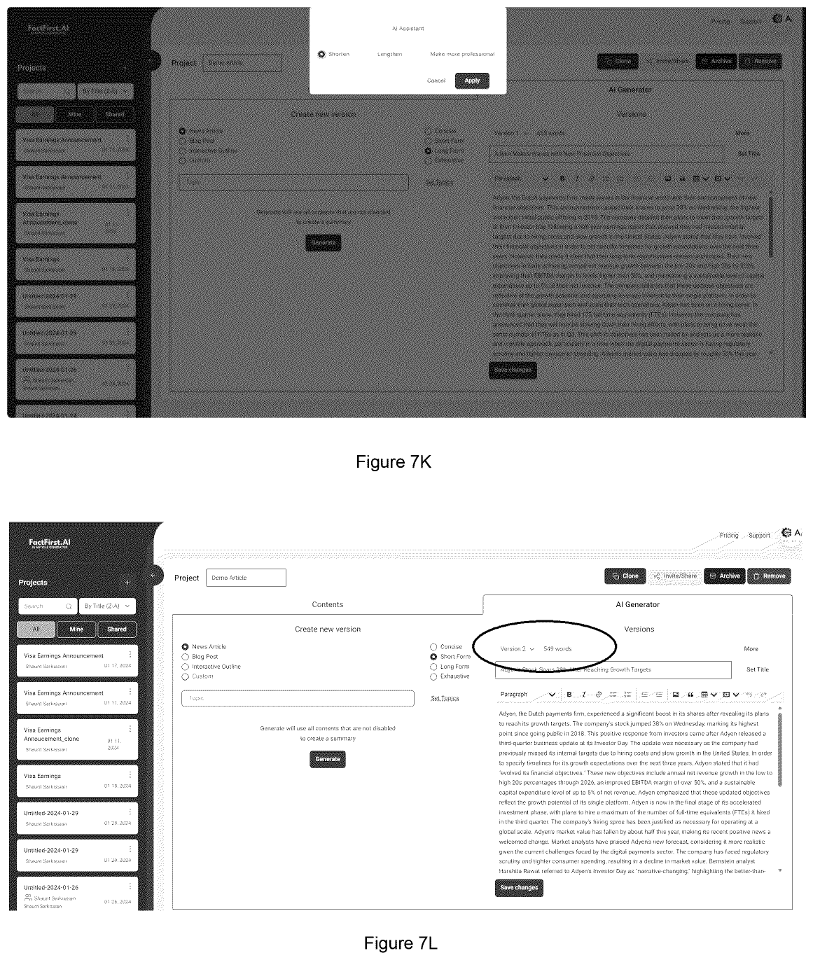

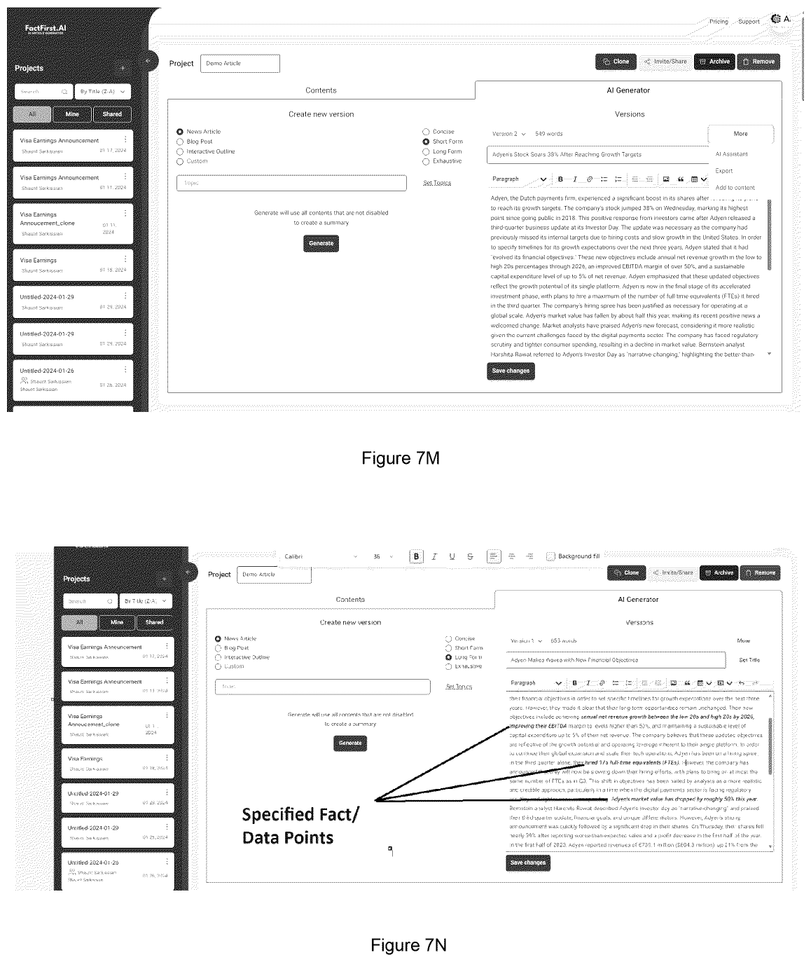

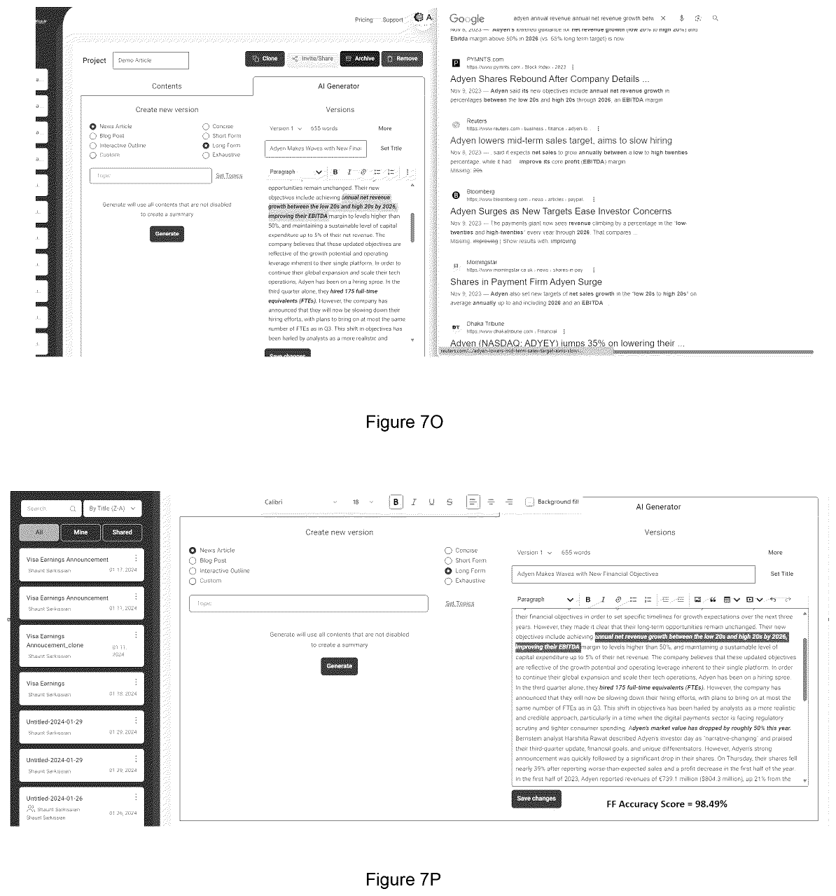

FIGS. 7A-7P are schematic diagrams of an automated content generation interface according to the present invention. FIG. 7A illustrates an interface including a main component and a project column component. The main component is used to create a new project and the project column component tracks all existing projects, both completed and in progress. FIG. 7B illustrates an interface for searching for a topic within input source material (e.g., file, link, document) along with a historical period for the input source material (e.g., hour, day, week, month, year) as well as the type of content to search for (e.g., news, web/Internet, video). As shown in FIG. 7C, the input source material searched for may be across websites such as Google, larger search engines, or limited to particular sources (e.g., WSJ.com). FIG. 7D illustrates the interface providing the results from the search. The search results are listed in the order of most relatable to the topic and includes the title of the work, source obtained from, date of publication, and portions of the publication. FIG. 7E illustrates the interface with further details of a particular source. A user may either hover over a particular search result or select it to review the entire work from the source material. FIG. 7F illustrates the interface with source material selected by the user and grouped within a “content selected” column component of the main component. FIG. 7G illustrates the interface with further details of a particular source, but in a format that can be customized, edited, modified and saved before being used by the system to create the content. FIG. 7H illustrates the interface with selections for the user. Here, the user makes certain selections for the content they wish the system and method to generate, for example, a news article or blog post or outline. Additionally, the length of the desired generated content is selected. In a preferred embodiment, the length is defined as “concise” (155-250 words), “short” (350-400 words), “long” (500-700 words). Further selections may include a tone (exact, focused, balanced, creative) for the content to be created, as well as whether to include quotes from the input reference sources. FIG. 7I illustrates the interface providing the content created. It is noted that the first returned result is identified as “version 1”, with any subsequent change(s) made (either by the user or the system) identified as a greater version number. FIG. 7J illustrates the interface providing suggested title recommendations or the content generated. The user may modify the suggested titles if desired. FIG. 7K illustrates the interface with options to further refine the content generated. For example, the generated content may be further shortened or lengthened if the result is too short. It should be noted that any change to the content increments its version number. FIG. 7L illustrates the interface providing all versions of the content created. A user may toggle through all versions of the created content. FIG. 7M illustrates the interface with the created content selected for export and use. The content created may be output to an API for publication as a soft copy to a website or blog post, a hard copy document (newspaper, newsletter, magazine, etc.), or to a file exported in any format, e.g., TXT, PDF, DOC. FIGS. 7N-7P illustrate the interface for verification. Verification is performed by fact screening and scoring the output content created to protect the content from errors or false information. As shown in FIG. 7N fact based data points are highlighted (such as by bold lettering, italic lettering, underline) within the content generated. The fact based data points are any referenceable data for example numerical values. Upon selecting a particular highlighted fact based data point, a verification column component is generated that lists the corresponding references from which this highlighted data point is verifiable. FIG. 70 illustrates the interface showing the highlighted data points and the verification column component including the corresponding references from which this highlighted data point is verifiable. FIG. 7P illustrates the accuracy score of the content generated. A score is assigned by analyzing the content generated as compared to the input reference sources and/or outside sources (i.e., existing materials or other forms of media related to the topic). Each discrepancy between the sources and the generated content is assigned a negative value and summed so that this accuracy score can be compared to a threshold value. The accuracy score of the generated content may be communicated as a value, or as shown here, a percentage.

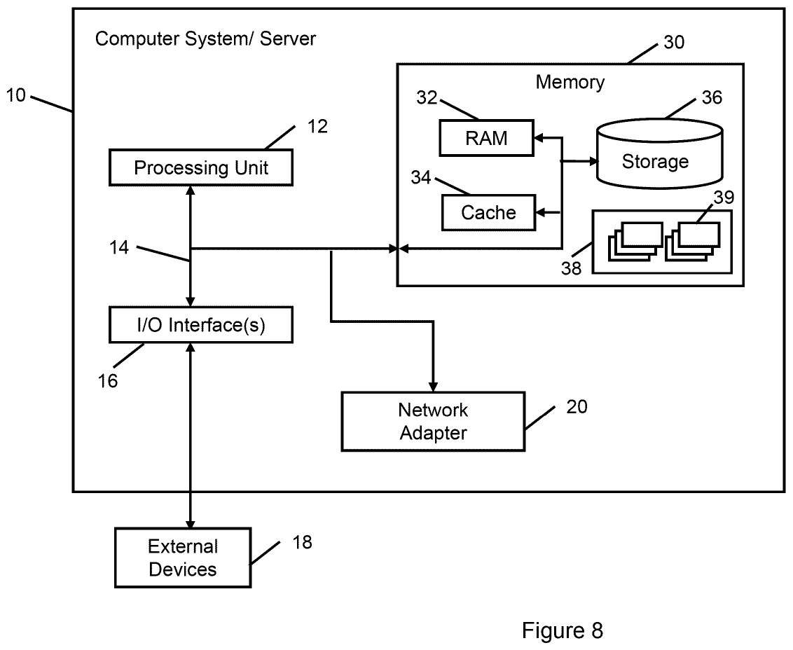

FIG. 8 illustrates a block diagram of an example computer system/server 10 adapted to implement the present invention. The computer system/server 10 shown in FIG. 8 is only an example and should not bring about any limitation to the function and scope of use of the embodiments of the present disclosure.

As shown in FIG. 8, the computer system/server 10 is shown in the form of a general-purpose computing device. The components of computer system/server 10 may include, but are not limited to, one or more processors (processing units) 12, a memory 30, and a bus 14 that couples various system components including system memory 30 and the processor 12.

Bus 14 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 10 typically includes a variety of computer system readable media. Such media may be any available media that is accessible by computer system/server 10, and it includes both volatile and non-volatile media, removable and non-removable media.

Memory 30 can include computer system readable media in the form of volatile memory, such as random access memory (RAM) 32 and/or cache memory 34. Computer system/server 10 may further include other removable/non-removable, volatile/non-volatile computer system storage media. By way of example only, storage system 36 can be provided for reading from and writing to a non-removable, non-volatile magnetic media (not shown in FIG. 8 and typically called a “hard drive”). Although not shown in FIG. 8, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 14 by one or more data media interfaces. The memory 30 may include at least one program product having a set (e.g., at least one) of program modules that are configured to carry out the functions of embodiments of the present disclosure.

Program/utility 38, having a set (at least one) of program modules 39, may be stored in the system memory 30 by way of example, and not limitation, as well as an operating system, one or more disclosure programs, other program modules, and program data. Each of these examples or a certain combination thereof might include the implementation of a networking environment. Program modules 39 generally carry out the functions and/or methodologies of embodiments of the present disclosure.

Computer system/server 10 may also communicate with one or more external devices 18 such as a keyboard, a pointing device, a display, or any known devices that enable a user to interact with computer system/server 10, and/or with any devices (e.g., network card, modem, etc.) that enable computer system/server 10 to communicate with one or more other computing devices. The external devices 18 may be a handheld device and include any small-sized computer device including, for example, a personal digital assistant (PDA), smart hand-held computing device, cellular telephone, or a laptop or netbook computer, handheld console or MP3 player, tablet, or similar handheld computer device, such as an iPad or iPhone.

Such communication can occur via Input/Output (I/O) interfaces 16. Still yet, computer system/server 10 can communicate with one or more networks such as a local area network (LAN), a general wide area network (WAN), and/or a public network (e.g., the Internet) via network adapter 20. As depicted in FIG. 8, network adapter 20 communicates with the other communication modules of computer system/server 10 via bus 14. It should be understood that although not shown, other hardware and/or software modules could be used in conjunction with computer system/server 10, for example, device drivers, redundant processing units, external disk drive arrays, and data archival storage systems, etc.

The processor 12 executes various function applications and data processing by running programs stored in the memory 30, for example, implement the method in the embodiment shown in FIG. 1, namely, select input source material, obtain the words and structured data of the information conveyed by each input source material selected, generate a writing model based on the information obtained, wherein the writing model is assisted by AI to automatically create a news article with respect to the information obtained from the selected input source material.

The present disclosure meanwhile provides a computer-readable storage medium on which a computer program is stored, the program, when executed by the processor, implementing the method stated in the embodiment shown in FIGS. 1-4.

The computer-readable medium of the present embodiment may employ any combination of one or more computer-readable media. The machine-readable medium may be a machine-readable signal medium or a machine-readable storage medium. A machine-readable medium may include, but not limited to, an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that includes or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object-oriented programming language such as Java, Smalltalk, C++ or the like, and conventional procedural programming languages, such as the “C” programming language or similar programming languages. The program code may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

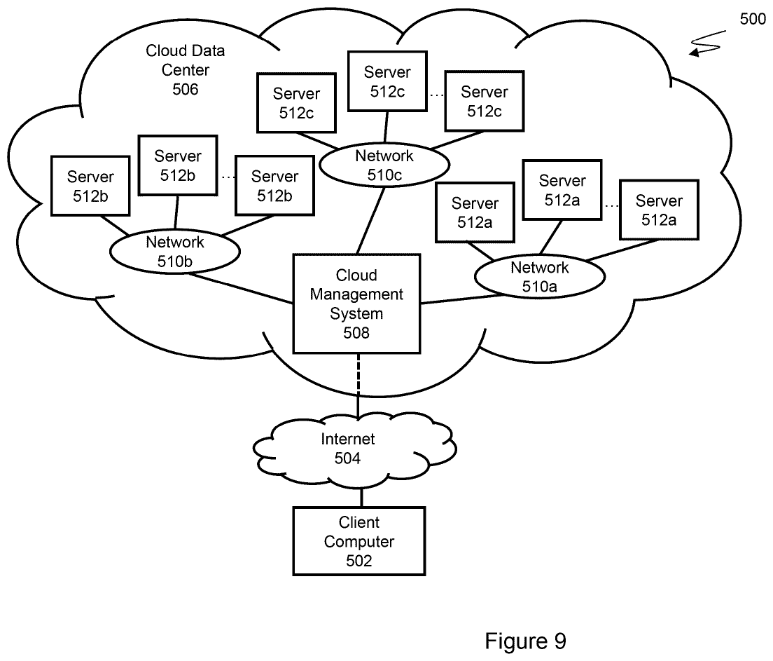

FIG. 9 illustrates an exemplary cloud computing system for use with the present invention, particularly in embodiments where the present invention is offered as a cloud-based technology that allows users to access software applications over the Internet, known as Software as a Service (SaaS).

A cloud service provider (CSP) hosts and manages the software and infrastructure of the cloud computing system 500, which comprises a plurality of interconnected computing environments. The cloud computing system 500 utilizes the resources from various networks as a collective virtual computer, where the services and applications can run independently from a particular computer or server configuration making hardware less important.

Specifically, the cloud computing system 500 includes at least one client computer 502. The client computer 502 may be any device through the use of which a distributed computing environment may be accessed to perform the methods disclosed herein, for example, a traditional computer, portable computer, mobile phone, personal digital assistant, tablet to name a few. The client computer 502 includes memory such as random-access memory (RAM), read-only memory (ROM), mass storage device, or any combination thereof. The memory functions as a computer usable storage medium, otherwise referred to as a computer readable storage medium, to store and/or access computer software and/or instructions.

The client computer 502 also includes a communications interface, for example, a modem, a network interface (such as an Ethernet card), a communications port, a PCMCIA slot and card, wired or wireless systems, etc. The communications interface allows communication through transferred signals between the client computer 502 and external devices including networks such as the Internet 504 and cloud data center 506. Communication may be implemented using wireless or wired capabilities such as cable, fiber optics, a phone line, a cellular phone link, radio waves or other communication channels.

The client computer 502 establishes communication with the Internet 504-specifically to one or more servers—to, in turn, establish communication with one or more cloud data centers 506. A cloud data center 506 includes one or more networks 510a, 510b, 510c managed through a cloud management system 508. Each network 510a, 510b, 510c includes resource servers 512a, 512b, 512c, respectively. Servers 512a, 512b, 512c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 508 can comprise a dedicated or centralized server and/or other software, hardware, and network tools to communicate with one or more networks 510a, 510b, 510c, such as the Internet or other public or private network, with all sets of resource servers 512a, 512b, 512c. The cloud management system 508 may be configured to query and identify the computing resources and components managed by the set of resource servers 512a, 512b, 512c needed and available for use in the cloud data center 506. Specifically, the cloud management system 508 may be configured to identify the hardware resources and components such as type and amount of processing power, type and amount of memory, type and amount of storage, type and amount of network bandwidth and the like, of the set of resource servers 512a, 512b, 512c needed and available for use in the cloud data center 506. Likewise, the cloud management system 508 can be configured to identify the software resources and components, such as type of Operating System (OS), application programs, and the like, of the set of resource servers 512a, 512b, 512c needed and available for use in the cloud data center 506.

The present invention is also directed to computer products, otherwise referred to as computer program products, to provide software for the cloud computing system 500. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (MEMS), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

What are stated above are only preferred embodiments of the present disclosure and not intended to limit the present disclosure. Any modifications, equivalent substitutions and improvements made within the spirit and principle of the present disclosure should all be included in the extent of protection of the present disclosure.

1. A method of generating content assisted by artificial intelligence (AI), wherein the method comprises the steps of:
entering a length for output content;
selecting two or more source materials and determining the length of each of the two or more selected source materials;
obtaining word information and structured data information of each of the two or more selected source materials;
generating a writing model according to the obtained word information and structured data information, comprising the steps of:
normalizing time of each of the two or more selected source materials,
extracting content from the two or more selected source materials,
choosing quotes from the extracted content;
generating output content, wherein the generated output content matches the entered length;
correcting errant quotes in the generated output content; and
displaying the output content wherein the length of the displayed output content is less than or equal to the length of the two or more selected source materials.

2. The method of generating content assisted by AI according to claim 1, wherein the content generated is a news article.

3. The method of generating content assisted by AI according to claim 1, wherein the normalizing step further comprises the steps of:
locating all time references in the text of the input source material;
identifying each time reference as a primary time reference, an absolute time reference, or a secondary time reference;
wherein a time reference located inside a quote is annotated with the absolute time reference and a time reference located outside a quote is converted to the absolute time reference, annotated to the secondary time reference, or removed.

4. The method of generating content assisted by AI according to claim 1, wherein the correcting step further comprises the steps of:
identifying and extracting original quotes in the two or more source materials, computing, for each original quote extracted from source materials, a token vector;
using nearest-neighbor token vectorization to store the token vectors of the original quotes;
creating a token vector for each quote in the generated output content;
performing a nearest-neighbor search to find the closest quote in the two or more selected source materials;
wherein a quote that is different is replaced with the original quote or the quotation marks are removed.
